(19) United States
(12) Patent Application Publication
(10) Pub. No.: US 2002/0194131 A1
(43) Pub. Date: Dec. 19, 2002

(54) Method and system for electronically transmitting authorization to release medical information

(76) Inventor: Richard S. Dick, Alpine, UT (US)

Correspondence Address: KIRTON AND MCCONKIE, 1800 EAGLE GATE TOWER, 60 EAST SOUTH TEMPLE, P O BOX 45120, SALT LAKE CITY, UT, 84145-0120, US

(21) Appl. No.: 09/883,884

(22) Filed: Jun. 18, 2001

(51) Int. Cl. G06F 17/60

(52) U.S. Cl. 705/51

(57) ABSTRACT

The present invention relates to a method and system for searching for medical information. The method of searching may be executed by one or more computers. The present invention comprises the steps of searching for a person's medical information by first receiving a request for medical information from a requester including identification of the and by receiving digitally signed authorization to release the medical information. A query is then transmitted to a medical information repository for information pursuant to the request; and a response to the request based on the query is transmitted.

### BACKGROUND OF THE INVENTION

The medical and health care records of an individual are highly personal documents often containing private, sensitive information. The release of medical information for commercial use is strictly regulated by state and federal law. Thus medical records are becoming more generally available in electronic form, but electronic signatures authorizing their release to others are not today easily accessible. Because such records are highly sensitive, the records are protected by laws requiring patient consent prior to release or disclosure to others.

Medical information, while sensitive, is also valuable to certain businesses. Common uses for medical information include physician reference and diagnosis, medical research, medical training, insurance policy underwriting and claims adjusting. Many fields of insurance (e.g., life, health, disability income, long term care, property and casualty, and reinsurance) use such information. Such analyses of medical information typically include reviewing attending physician's statements and other medical records. Medical records may be used to help determine the risk presented by an insurance applicant. Medical records can also help determine causation and other issues relevant to claims adjusting.

Obtaining authenticated medical information from health care providers can be time consuming. Since many medical records exist only in paper form, there are ongoing efforts in the medical industry to convert old paper records into an electronic format and to generate all new records in an electronic format. The ability to store and distribute records electronically will greatly facilitate the retrieval of these medical records saving time and money, and potentially eliminating the significant cost of manual retrieval.

For example, medical information for the issuance of an insurance policy may be retrieved by one or more computers. One computer receives a request for medical information including identification of a subject and then transmits the query to another computer at a medical information repository for information pursuant to the request. The first computer then receives a response to the query containing medical information.

Just as insurance companies lack access to the medical records they need, health care providers and emergency medical technicians also have a need for access to medical records regarding patients which presently goes unmet. Health care providers and emergency medical technicians are sometimes required to make decisions regarding how to care for a patient under circumstances in which paper records such as physician-based records are not readily available. The process of obtaining and utilizing information from a patient's paper based medical records may prove too slow to provide information that may be helpful or in some cases crucial for proper care of the patient. The prior art systems' shortcomings in this area increase the risk of improper treatment for the patient and increase the likelihood of malpractice by the healthcare providers and emergency medical technicians.

Even with the advantages of the electronic medical records systems which allow medical records to be stored and transferred electronically, in many instances the laws still require that a request for a person's medical records to be accompanied by a signed authorization or consent from the patient/person/guardian to release the medical information. This presents a significant problem for those attempting to obtain such records manually or electronically. In order to use abide by legal and ethical requirements, present methods and systems for obtaining medical records rely on facsimile transmission of consent forms. Parties requesting medical information must transmit facsimile copies of signed release forms to the medical record keeper, which the record keep then receives and files. This greatly slows an otherwise efficient process and requires the transmittal and storage of paper documents.

What is needed is a method and system allowing a person to execute a consent to release medical records that is legally effective and can be transmitted and stored electronically. It would also be advantageous to provide such a method and system in a way that reduces the likelihood of fraud in obtaining the release of the records.

### SUMMARY AND OBJECTS OF THE INVENTION

In order to further facilitate the secure, prompt exchange of valuable medical information electronically, the present invention provides for the use of digital signature technology to fulfill the legal requirement for signed authorization for the release of medical information. Digital signatures allow authenticated and legally binding documents to be generated, distributed and signed electronically. The use of digital signatures allows the entire medical record request process to be accomplished electronically and in many cases will allow the entire information gathering process to be transacted online and nearly instantaneously. In order to more fully authenticate the person's authorization for a transaction, biometric authentication is integrated into the digital signature process to reduce the chances of information being obtained by a forged or fraudulent digital release form.

Thus, in order to transmit requested medical information, a first computer receives a request for medical information including identification of a subject and a digitally signed information release form. The identity of the person authenticating the release form is confirmed using biometric identification and authentication. The first computer transmits the query and the digitally signed release form to a second computer at a medical information repository. Alternatively, the computer could send the request to a third party acting in behalf of the patient to retrieve their records stored at a medical information repository for information pursuant to the request. The first computer then receives a response to the query containing medical information. The digital signature and biometric identification may be confirmed as authentic by both the party receiving the request or by another third party.

Where a health care provider has and maintains medical records of an individual and the individual requests copies of those records for use by the individual or a third party, by law the health care provider is required to deliver copies of the requested records to the individual or third party. The health care provider is also required to retain a copy of which records were delivered and to whom. Thus, using the method of the present invention, the process of requesting and delivering such documents is greatly facilitated, as is the subsequent storage of the request and response.

The method of the present invention contemplates the use of digital signature and digital certification, to expedite the records retrieval process and to comply with the associated legal requirements. However, it has been reported that digital signatures have in some circumstances been misappropriated and used to commit fraudulent transactions. Having immediate access online to medical information such as prescription history and medical records (made possible by the use of the novel method) raises potential risks if the consent for release of the information cannot be verified as authentic.

The present invention employs biometric authentication in combination with digital certificates and digital signatures to greatly increase the security of the system and to help prevent unauthorized requests for access. Certain biological traits, such as the unique characteristics of each person's fingerprint, iris scans, and facial features have been measured and compared and found to be unique or substantially unique for each person. These traits are referred to as biometrics. The computer and electronics industry is developing identification and authentication means that measure and compare certain biometrics with the intention of using them as biological “keys” or “passwords.” Other means for securing the system could be employed in addition to those disclosed above.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 illustrates a flowchart of a preferred embodiment of the present invention.

FIG. 2 illustrates several preferred physical environments in which the method of the preferred embodiment may be carried out.

### DETAILED DESCRIPTION OF THE PREFERRED EMBODIMENTS

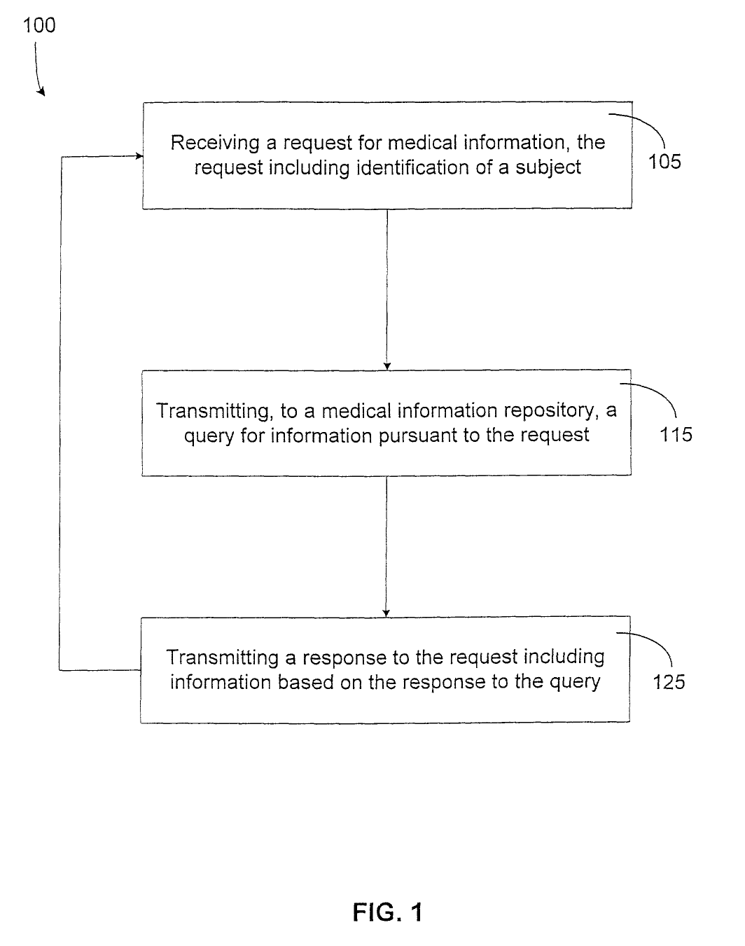

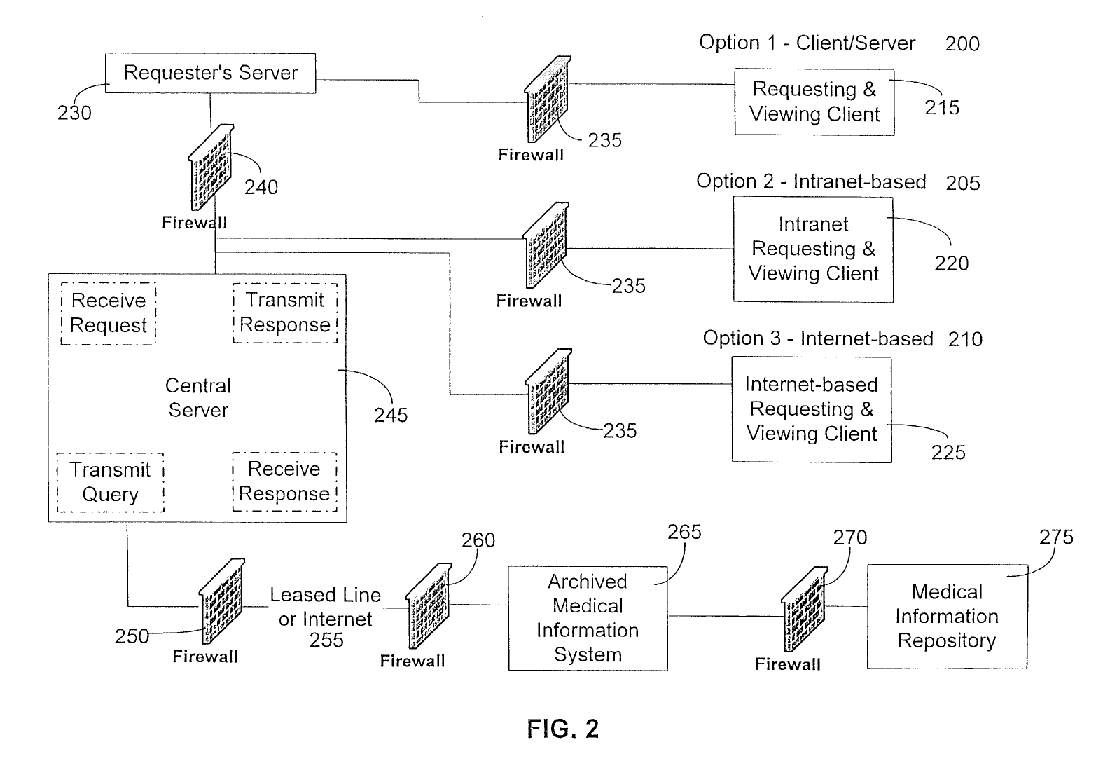

It will be readily understood that the components of the present invention, as generally described and illustrated in the figures herein, could be arranged and designed in a wide variety of different configurations. Thus, the following more detailed description of the embodiments of the system and method of the present invention, and represented in FIGS. 1 and 2 is not intended to limit the scope of the invention, as claimed, but is merely representative of the presently preferred embodiments of the invention.

The presently preferred embodiments of the invention will be best understood by reference to the drawings, wherein like parts are designated by like numerals throughout.

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The present invention comprises the steps of searching for a person's medical information by first receiving a request for medical information from a requester and receiving digitally signed authorization to release the medical information. A query is then transmitted to a medical information repository for information pursuant to the request; and a response to the request based on the query is transmitted.

More specifically, the present invention relates to methods and apparatus for electronically providing legally effective medical information release forms electronically in order to obtain electronic access to patient medical records created by health care providers working at healthcare facilities, which includes but is not limited to clinical records, lab records, billing coded information, and prescription drug records. The system works most efficiently when a healthcare facility is utilizing a computer information system (CIS) for creating, managing and/or storing computerized patient records or electronic medical records, but the system can work advantageously with virtually any type of digitized medical record or even to facilitate electronic receipt of authenticated digitally signed authorizations for retrieval of paper-based medical information. The preferred embodiment of the system and method comprise a request facilitator which receives requests for medical records from a requestor such as an insurance company, physician, etc. and forwards the request directly or through a facilitating party to the appropriate healthcare facility or physician. As used herein, the term “healthcare facility” refers to any office, building or location, physical or electronic, where healthcare related services are rendered, including but not limited to clinics, hospitals, pharmacies, laboratories, healthcare providers and other medical information repositories. The request includes a release form that is digitally signed and biometrically authenticated.

By including a release form that is digitally signed and biometrically authenticated, the healthcare provider is alleviated of the need to inquire as to whether the request is legitimate and records can be released with full confidence of the integrity of the signed authorization. For purposes of this application, a healthcare provider can be any person or organization that renders healthcare related services, including but not limited to clinics hospitals, pharmacies and labs. Having received the request and release of the records and after having verified authorization to do so, the healthcare provider manually or automatically releases the records, forwarding them to the facilitator; the records are then forwarded to the requestor. Alternatively, the records may be forwarded directly to the requestor. The health care provider can then electronically store copies of the request, the release form and the information transmitted as may be required.

The use of a combined digital signature and biometric authentication may also be used in the processes of searching the medical information repository for information regarding a patient or healthcare provider for financial transactions and payment to healthcare facilities. Benefits of the present invention is these process include a reduction in response time to requests and better security than faxing the information. Further, a healthcare facility's staff are not overburdened by requests for information because computers process and handle the requests for release. Since access is preferably electronic, information requesters may not have to incur traditional manual retrieval and storage of requested information. Additionally, the technology may be applicable and advantageous to manual retrieval of records where no electronic medical information exists.

The widespread use of the present invention may facilitate a standardized authorization format for the release and transmission of medical information by healthcare providers, helping to integrate otherwise disparate healthcare practices. Healthcare facilities and providers, clinics, hospitals, pharmacies, laboratories and medical information repositories can share and exchange information in confidence, knowing that the flow of information is legally authorized by the patient or owner of the information and that it is secure. This could greatly improve the quality and efficiency of healthcare services.

The present invention contemplates the use of one or more methods for securing documents by the use of digital signature and biometric identification. Digital signatures can provide both encoding and authentication of documents being transmitted. The document can be encoded so that only the intended receiving computer can read and decipher the document. The document can also be authenticated using an electronic means or process for verifying that the source of the information being sent is a trusted or known source. Authenticating the document can be done by the use of passwords, check sum verification, hashing algorithms, cyclic redundancy check verification, and other authentication tools and systems.

In the preferred embodiment of the present invention, digital signatures are accomplished using key encryption. Private key encryption may be preferred in circumstances in which it is known which particular computer will send the electronic data and which particular computer will receive the data. A private encryption key is installed on each of the computers allowing them to transmit encoded information over a computer network.

In some embodiments of the present invention, circumstances may require the use of public key encryption, wherein the transmitting computer retains the private key and the public key is distributed to other computers for secure communication with the originating computer. In a multiple network environment, such as the internet, in order to employ public key encryption it is necessary to include a certificate authority to verify the authenticity of the parties wishing to communicate securely and to distribute the public encryption keys necessary for a secure communication.

The digital signature technology which, though legally sufficient for the release of the information, by itself may be considered insufficient for security purposes, can be combined with biometric technologies. Biometrics for authentication and identification purposes include the use of measurements of unique visible features such as fingerprints, hand and face geometry, and retinal and iris patterns, as well as the measurement of unique behavioral responses such as the recognition of vocal patterns and the analysis of hand movements. The use of each of these biometrics requires a device to make the biological measurement and process it in electronic form. The device may measure and compare the unique spacing of the features of a person's face or hand and compare the measured value with a value stored in the device's memory. Where the values match, the person is identified or authorized. The use of internal biometrics based upon physiological, histological and chemical/genetic measurements are being proposed and developed and may also be used in combination with a digital signature.

Several types of technologies are used in biometric identification of superficial anatomical traits. For example, biometric fingerprint identification systems may require the individual being identified to place their finger on a visual scanner. The scanner reflects light off of the person's finger and records the way the light is reflected off of the ridges that make up the fingerprint including detection of whether the digit is still connected to a living being. Hand and face identification systems use scanners or cameras to detect the relative anatomical structure and geometry of the person's face or hand. Different technologies are used for biometric authentication using the person's eye. For retinal scans, a person will place their eye close to or upon a retinal scanning device. The scanning device will scan the retina to form an electronic version of the unique blood vessel pattern in the retina. An iris scan records the unique contrasting patterns of a person's iris.

Still other types of technologies are used for biometric identification of behavioral traits. Voice recognition systems generally use a telephone or microphone to record the voice pattern of the user received. Usually the user will repeat a standard or predetermined phrase, and the device compares the measured voice pattern to a voice pattern stored in the system. Signature authentication is a more sophisticated approach to the universal use of signatures as authentication. Biometric signature verification not only makes a record of the pattern of the contact between the writing utensil and the recording device, but also measures and records speed and pressure applied in the process of writing.

FIG. 1 shows a flowchart of a preferred embodiment using digitally signed and biometrically authenticated information release form, in accordance with the present invention. Medical Information 100 encompasses all information relating to physical and mental health diagnoses and remedies such as physician-patient records, clinical information records and prescription drug records. Clinical information includes laboratory testing, ambulatory, home health, and long-term care among other sources of clinical care and information.

The illustrative method in FIG. 1 includes receiving a request for medical information including identification of a subject and a digitally signed and biometrically authenticated information release form 105; transmitting a query and if necessary, the digitally signed release form to a medical information repository for information pursuant to the request 115; and transmitting a response to the request for medical information, including information based on the response to the query 125. A variation of the method and system described in FIG. 1 includes the additional steps of using a third party to electronically verify the request and release 110 and receiving a response to the query containing medical information 120. In aid of further description, the illustrative method in FIG. 1 will be described according to the several physical environments shown in FIG. 2.

FIG. 2 illustrates several preferred physical environments in which a digitally signed and biometrically authenticated information release form carried out in search of medical information. Specifically, three front-end physical environments capable of generating and transmitting a digitally signed and biometrically authenticated information release form are shown, a client-server environment 200, an intranet-based environment 205, and an internet-based environment 210. Each front-end physical environment includes one or more requesting and viewing clients (“RVC”s), respectively, client-server-based 215, intranet-based 220, and internet-based 225.

An RVC is typically a terminal having at least a video display and keyboard and biometric authentication hardware. In general, each RVC is operated by an authorized user to request and possibly another authorized used who has distinctly separate privileges such as being able to subsequently review retrieved medical information or other search results. In light of the sensitive nature of medical information, security is of utmost importance. A variety of additional security measures could be employed to ensure that only authorized users obtain access.

Each RVC operates to receive a request for medical information according to its configuration. Generally, each RVC will receive such a request via an authorized user's responses to prompts generated by executing software displayed on the RVC video display. More specifically, a client-server RVC 215 would receive a request from an authorized user responding to prompts from software executing on requestor's server 230 or on RVC 215. An intranet-based RVC 220 would receive a request from an authorized user responding to prompts from software executed by RVC 220. An internet-based RVC 225 would receive a request from an authorized user responding to prompts from internet browser software executed by RVC 225 wherein the browser software is executing instructions received by an internet website accessed through the browser software.

In each of the three physical environments shown, RVCs are protected by at least one firewall 235 to deter unauthorized access. In the case of the client-server RVC 215, three firewall layers are shown in FIG. 2, double firewall 240 in combination with firewall 235. An RVC is part of a network, wherein network is broadly defined to encompass any configuration of operably connected computers, including wired or wireless connectivity over an intranet, the internet, modems, phone lines, satellites, wireless transmitters and receivers, optical lines, firewalls, servers, relays, bridges, repeaters, etc.

Each request for medical information includes identification of a subject and digitally signed and biometrically authenticated information release form. A subject might consist of a human individual or group of humans. The subject is the target of the search for medical information. The identification of the subject could be by way of name, patient number, social security number, driver's license number, address, phone number, biometric identification or any other identification or combination of identification characteristics capable of being correlated with stored medical information, if it exists. The identification may be integral within or in addition to the digitally signed and biometrically authenticated request form.

The request may originate with any party desiring the medical information. The request may originate with insurance agencies, health care providers and professionals, and emergency medical technicians. In some embodiments of the present invention, the request originates with a medical information repository (MIR) itself. The request may be received directly by the MIR via an RVC controlled by the MIR or may be received by an RVC that then routes the request to the MIR. The term medical information repository includes medical information repository or health care provider such as a physician's office or clinical laboratory.

In the present method, consent of the subject(s) is required to obtain the medical information. The digitally signed information release form is typically documentation of the subject's consent, or their legal representative's consent, to the disclosure of medical information. Such documentation can be in image or machine-readable format. In the preferred embodiment, the digitally signed and biometrically authenticated information release form is an integral part of the request. This method eliminates the necessity of scanning, transmitting, or sending paper documents, as the subject or their authorized representative electronically signs an information release form. In some situations the requester, by means equivalent to a digitally signed and biometrically authenticated information release form, may electronically certify their possession of a signed information release, such as where the law requires the presentment of a release but does not require the record provider to maintain a copy of the release.

In the preferred embodiment shown in FIG. 2 verification of the release is performed once the request and release are received by an RVC, the request is transmitted to and received by a central server 245. A central server may consist of multiple computers performing specific tasks or executing independent processes. When central server 245 receives a request for medical information 105, it may verify the request 110 before it sends a response to the request 125. Request verification 110 can take many forms, but most likely will be driven by the satisfaction of legal and security requirements. In the preferred embodiment the verification includes confirmation receipt of digitally signed information release form. Verification is communicated to the request handling software executing on the central server 245. An example of request verification 110 also includes electronic verification of an electronic watermark, biometric authentication or digital certificate submitted with the request. A further example includes verification of the user identified as originating the request for information or verification by source recognition, for instance a recognized account code, a request authorization code assigned by software, a hardware address, or the like.

Following receipt of the request for information 105, the Central Server 245 will transmit a query to a medical information repository 275 for information pursuant to the request 115. The query will preferably include a copy of the digitally signed and biometrically authenticated information release form depending on the procedure in place at the medical information repository and legal requirements. As explained above, a medical information repository includes pharmacy benefit managers (“PBM”s), pharmacies, and any other medical information repository such as a physician's office or clinical laboratory. PBMs are companies contracted by health insurers and self-insured employers to manage prescription drug programs.

The path of the transmitted query 115 to the medical information repository may include one or more firewalls, 250 and 260, as depicted in FIG. 2. Firewall 250 prevents unauthorized access to the central server 245. The particular method of communication is unimportant as long as information security measures are taken. The most common forms of communication are depicted in FIG. 2 as leased line or internet 255.

In the preferred embodiment shown in FIG. 3 an optional intermediate archived medical information system (AMIS) is employed. There are several benefits to utilizing an AMIS server 265. The AMIS server 265 removes the computing burden from medical information repositories such as MIR 275 by processing requests for information. The AMIS server 265 also allows for system maintenance and upgrades without disrupting medical information repository systems. The AMIS server 265 can also be used to archive medical information for longer periods of time than may be established for MIR 275. The period of archival in the AMIS server 265 could be any length of time. The AMIS server 265 may be associated with one or more MIRs and may be networked with the MIR to receive data directly from the MIR or may be wholly removed from the MIR, receiving data indirectly.

When AMIS server 265 has completed information searches responsive to the query from central server 245, AMIS server 265 will transmit a response to central server 245 conveying the results ofthe search(es) made pursuant to the query/queries sent by central server 245. Central server 245 will thus receive one or more responses to its one or more queries 120. Following receipt of a response to its query 120, central server 245 will return a response to the request 125.

When central server 245 receives the response to its query 120, it will prepare a response to the request received 105 from an RVC. If more than one query was made, central server 245 will compile the responses to the queries prior to returning the response to the request 125. The response to the request will be based, at least in part, on information contained in the response to the query 120. Depending on the results of the search, the response to the request 125 may even convey no results if that is conveyed in the response to the query 120. Similarly, messages similar to “information repository unavailable” may be required from time to time.

The information requested from the various medical information repositories may be stored in formats that are generic, incompatible or in some way undesirable. When information relative to request is located by the search, the information may be advantageously compiled and reformatted. The AIMS server or the central server may operate to reformat and/or compile the responses received, before the response is ultimately transmitted to the intended receiver. The response may be advantageously reformatted in a several ways. For example, the information may be reformatted to facilitate transmission, to safeguard confidentiality, or to make the information more user friendly. Alternatively, if the various medical information repositories store medical information in formats that are incompatible or undesirable, the repositories themselves may be advantageously reformatted. The information received could also be advantageously reformatted by the RVC or by the intended recipient. Once properly formatted, the response to the request may be sent directly to the intended recipient from the MIR or AIMS. Alternatively the response may be transmitted to the intended recipient through the RVC.

With the inclusion of digitally signed and biometrically authenticated release forms, the computerization of the medical record retrieval is complete and no human-induced delays are encountered. Thus, retrieval of medical information occurs in near real-time as opposed to the usual several week delay in obtaining physician-based records, clinical records, and other paper-based medical records. Because of the speedy authorization and retrieval of medical information and the elimination of the need to fax or exchange release forms, requesters such as insurance companies will not incur unnecessary expenses.

In order to further facilitate the rapid retrieval of medical information, the present invention also contemplates the optional use of real time issuance of digital certificates. Digital certificates can be issued in real time through a process wherein a certificate authority verifies that that person applying for the certificate is in fact the person they claim to be by gathering historical facts and other identifying information about an individual found in various public and private information databases and testing the applicant's knowledge of such facts. Preferably the databases are accessible over a computer network so they can be searched on line. The present invention additionally includes the use of medical related information obtained online as “authenticating” information for real time issuance of digital certificates, exclusive of or in addition to other types of information.

The digital certificate, and hence any digital signatures associated with it, is thereby enhanced and made more certain of the identity of the individual including in it clinical information related to the signator. Such information might include but is not limited to the total or selected combination of drugs for a person, prescribing physicians, and pharmacies used to fill such prescriptions, or selected unique elements from certain computer-based patient records or electronic medical records, or from laboratory test results.

Additional benefits provided by a method implemented in accordance with the present invention, aside from overcoming the difficulties associated with the prior art, include: increased confidence in maintaining privacy while distributing medical records over the internet; the potential for real-time application and issuance of insurance policies, benefits for physicians, and especially emergency care physicians, for purposes of diagnosis; and increased revenue for insurance companies who lose business due to delays in retrieving authorization to release medical records The present invention facilitates rapid and potentially realtime retrieval of key, distinctive information that uniquely identifies an individual for rapid issuance of a digital certificate.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency ofthe claims are to be embraced within their scope.

What is claimed is:

1. A method of searching for medical information executed by one or more computers comprising:
(a) receiving a request for medical information from a requestor including and biometrically authenticated medical information release form bearing a digital signature;
(b) transmitting a query to a medical information repository for information pursuant to the request; and
(c) transmitting a response to the request including information based on the response to the query.

2. The method of claim 1, wherein the query is transmitted to the medical information repository by an internet website communicating with the medical information repository.

3. The method of claim 2, wherein a computer communicating with the internet website operates according to input from a device capable of detecting the presence of an authorized user.

4. The method of claim 1, further comprising receiving a response to the query.

5. A method of claim 4, wherein the response is transmitted directly to the requester.

6. The method of claim 1, wherein the digital is accomplished using private key encryption.

7. The method of claim 1, wherein said digital signature is accomplished using public key encryption.

8. The method of claim 1, further comprising verifying the release

9. The method of claim 8, wherein verifying the request includes verifying the source of the request using a digital certificate.

10. The method of claim 8, wherein verifying the request includes verifying the source of the request using cyclic redundancy check verification.

11. The method of claim 8, wherein verifying the request includes verifying the source of the request using passwords.

12. The method of claim 8, wherein verifying the request includes verifying the source of the request using check sum verification.

13. The method of claim 8, wherein verifying the request includes verifying the source of the request using hashing algorithms.

14. The method of claim 1, wherein the biometric authentication is a retinal eye scan.

15. The method of claim 1, wherein the biometric authentication is accomplished using is a hand writing signature recognition system.

16. The method of claim 1, wherein said digital signature is accomplished using electronic watermarks.

17. The method of claim 1, wherein the biometric authentication is a fingerprint scan.

18. The method of claim 1, wherein the biometric authentication is accomplished using a voice recognition system

19. A method of electronically transmitting authorization to release medical information over a computer network comprising:
(a) attaching a digital signature of an authorized individual to an electronic medical information release form requesting the release of a subject's medical information, said request including identification of the subject;
(b) biometrically authenticating the identity of the subject digitally signing the release form verifying the request;
(c) verifying said digital signature; and
(d) transmitting said digitally signed request form over a computer internet to a medical information repository.

20. The method of claim 19, wherein said digital signature is accomplished using private key encryption.

21. The method of claim 19, wherein said digital signature is accomplished using public key encryption.

22. The method of claim 19, wherein verifying the request includes verifying the source of the request using a digital certificate.

23. The method of claim 19, wherein verifying the request includes verifying the source of the request using cyclic redundancy check verification.

24. The method of claim 19, wherein verifying the request includes verifying the source of the request using passwords,

25. The method of claim 19, wherein verifying the request includes verifying the source of the request using check sum verification.

26. The method of claim 19, wherein verifying the request includes verifying the source of the request using hashing algorithms.

27. The method of claim 19, wherein the biometric authentication is a retinal eye scan.

28. The method of claim 19, wherein the biometric authentication is accomplished using is a hand writing signature recognition system.

29. The method of claim 19, wherein said digital signature is accomplished using electronic watermarks.

30. The method of claim 19, wherein the biometric authentication is a fingerprint scan.

31. The method of claim 19, wherein the biometric authentication is accomplished using a voice recognition system

32. The method of claim 19, wherein verifying the request includes verifying the digital signature on a medical information release form using a digital certificate.

33. A method for electronically requesting and obtaining a person's medical information comprising:
(a) receiving a request for medical information from a requester including identification of the subject;
(b) receiving a digitally signed authorization of the subject;
(c) authenticating the subject by biometric identification;
(d) authenticating the source of the request by biometric identification;
(e) integrating said authorization into a query;
(f) transmitting said query to a medical information repository for information pursuant to the request; and
(g) transmitting a response to the request based on the query.

34. A program storage device encoding instructions executable by one or more computers including instructions for performing the operations of:
(a) attaching a digital signature of an authorized individual to an electronic medical information release form requesting the release of a subject's medical information, said request including identification of the subject;
(b) biometrically authenticating the identity of the subject digitally signing the release form;
(c) verifying the request;
(d) verifying said digital signature; and
(e) transmitting said digitally signed request form over a computer internet to a medical information repository.
